(19) United States
(12) Patent Application Publication
(10) Pub. No.: US 2009/0122052 A1
(43) Pub. Date: May 14, 2009

(54) Overdrive apparatus for advancing the response time of a liquid crystal display

(76) Inventors: Ming-Sung Huang, Hsinchu (TW); Hsin-Lung Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,195

(22) Filed: Sep. 30, 2008

(30) Foreign Application Priority Data
Nov. 8, 2007 (TW) 096142283

(51) Int. Cl. G06F 3/038

(52) U.S. Cl. 345/213

(57) ABSTRACT

An overdrive apparatus for advancing the response time of a liquid crystal display (LCD) is disclosed, comprising a overdrive table, a memory storage, and a determining device, wherein the overdrive table is used for saving a plurality of overdrive-voltage values, the memory storage is used for saving a first frame, the determining device receives a first pixel, which is corresponding with a second pixel of the first frame, wherein the determining device can select an overdrive-voltage value from the overdrive table according to the first pixel and the second pixel, wherein the memory storage is provided within a first chipset, which comprises a first active face and a plurality of first bond pads provided on the first active face; the determining device is provided within a second chipset, which comprises a second active face and a plurality of second bond pads provided on the second active face, wherein the first chipset and the second chipset are stacked with each other, and the second bond pads are electrically connected to the first bond pads.

### FIELD OF THE INVENTION

The present invention relates to an overdrive apparatus, and more particularly to an overdrive apparatus for advancing the response time of a liquid crystal display (LCD).

### BACKGROUND OF THE INVENTION

Referring to FIG. 1(a), a block diagram of a general liquid crystal display (LCD) structure is showed. The LCD 10 comprises a liquid crystal panel 30, a gate driver 12, and a source driver 11, wherein the liquid crystal panel 30 comprises a plurality of scan lines 32, a plurality of data lines 34, and a plurality of pixels 36. Each pixel 36 is respectively connected to a corresponding scan line 32 and a corresponding data line 34; each pixel 36 comprises a switch 38 and a liquid crystal element 39. The gate driver 12 and the source driver 11 can be used for controlling the pixels through the scan lines 32 and the data lines 34 to show the image on the LCD 10.

Referring to FIG. 1(b), assuming that the voltage of the liquid crystal element 39 is Gₙ₋₁ while the time is on “n-1”, if the voltage of the liquid crystal element 39 would like to reach Gn while the time is on “n”, then the voltage of the liquid crystal element 39 might not reach Gn while the time is on “n” since the liquid crystal element 39 is driven with voltage Gn directly, due to the response time of the liquid crystal is too slow, as shown as line B. Therefore, for reducing the response time of the liquid crystal, the liquid crystal has to be driven by over-driving. For example, assuming that the voltage of the liquid crystal element 39 is Gₙ₋₁ while the time is on “n-1”, if the voltage of the liquid crystal element 39 would like to reach Gn while the time is on “n”, as shown as line C, then the voltage of the liquid crystal element 39 might reach Gn while the time is on “n” since the liquid crystal element 39 is overdriven to reach voltage Gn′, due to the response time of the liquid crystal is too slow, as shown as line A.

Generally, the overdrive process should be association with the overdrive table to find the proper voltage for driving on the liquid crystal element 39. Referring to FIG. 2(a), a table view of the original overdrive table is showed. The size of the overdrive gray level can be found according to the overdrive table. As shown on FIG. 2(a), the symbol “F2” is represented as the grey level of a specific pixel of the previous image, the symbol “F1” is represented as the grey level of a corresponding pixel of the current image, wherein the corresponding pixel is corresponding with the specific pixel of the previous image. For example, in respect of the 256 levels, 8 bits, gray level, the overdrive table thereof would be the size of 256×256×256 bit, namely 32K bytes. However, the control chipset of the general LCD cannot be supportable with such great quantity data, besides, the previous image data has to be saved in advance since the overdrive process would be proceeded. For example, if the resolution of each image is 800×600 dots per inch (dpi), then the gray level thereof should be the size of 800×600×256 bits according to the 256 levels, 8 bits, gray level, for each pixel, such that the control chipset of general LCD cannot be supportable.

Referring to FIG. 2(b), a table view of the shortened overdrive table is showed, which is reduced the resolution of the FIG. 2(a), and deleted the partial data thereof, for example, the 256 levels, 8 bits, gray level, can be deleted the rear five or four bits. The symbol “F2” is represented as the shortened grey level of a specific pixel of the previous image, the symbol “F1” is represented as the shortened grey level of a corresponding pixel of the current image, wherein the corresponding pixel is corresponding with the specific pixel of the previous image. Therefore, according to the overdrive table shown on FIG. 2(b), the size of the gray level has been shortened as 8×8×256 bit, namely 64 bytes, which is smaller than the original overdrive table obviously, however, due to the data quantity has been reduced, the response time of the liquid crystal would be slower or the image would be distortion since the voltage for overdriving is unsatisfied.

### SUMMARY OF THE INVENTION

It is a primary object of the present invention to provide an overdrive apparatus for advancing the response time of a liquid crystal display (LCD), which is used for reducing the response time of the LCD by the overdrive process.

It is a secondary object of the present invention to provide an overdrive apparatus for advancing the response time of a liquid crystal display (LCD), which is with the function of shortening the image size for saving the memory capacity.

It is another object of the present invention to provide an overdrive apparatus for advancing the response time of a liquid crystal display (LCD), which is packaged by the process of stacked integration package on package (PoP), such that the memory capacity of the overdrive apparatus can be without the limitation.

To achieve the previous mentioned objects, the present invention provides an overdrive apparatus for advancing the response time of a liquid crystal display (LCD), comprising a overdrive table for saving a plurality of overdrive-voltage values; a memory storage for saving a first frame; and a determining device for receiving a first pixel, wherein the first pixel is corresponding with a second pixel of the first frame, wherein the determining device is used for selecting an overdrive-voltage value from the overdrive table according to the first pixel and the second pixel; wherein memory storage is provided within a first chipset, and the first chipset comprises a first active face and a plurality of first bond pads provided on the active face; the determining device is provided within a second chipset, the second chipset comprises a second active face and a plurality of second bond pads provided on the second active face, wherein the first chipset and the second chipset are stacked with each other, the second bond pads are electrically connected to the first bond pads respectively.

To achieve the previous mentioned objects, the present invention further provides an overdrive apparatus for advancing the response time of a liquid crystal display (LCD), comprising a overdrive table for saving a plurality of overdrive-voltage values; a compressing device for compressing an original frame and generating a compressed frame; a memory storage for saving a first frame; a decompressing device for decompressing the compressed frame and generating a first frame; and a determining device for receiving a first pixel, wherein the first pixel is corresponding with a second pixel of the first frame, wherein the determining device is used for selecting an overdrive-voltage value from the overdrive table according to the first pixel and the second pixel; wherein memory storage is provided within a first chipset, and the first chipset comprises a first active face and a plurality of first bond pads provided on the active face; the determining device is provided within a second chipset, the second chipset comprises a second active face and a plurality of second bond pads provided on the second active face, wherein the first chipset and the second chipset are stacked with each other, the second bond pads are electrically connected to the first bond pads respectively.

To achieve the previous mentioned objects, the present invention further provides an overdrive apparatus for advancing the response time of a liquid crystal display (LCD), comprising a compressing overdrive table for saving a plurality of compressed overdrive-voltage values; an overdrive table decompressing device for decompressing the compressed overdrive-voltage values and generating a plurality of overdrive-voltage values; an overdrive table buffer for saving the overdrive-voltage values; a memory storage for saving a first frame; and a determining device for receiving a first pixel, wherein the first pixel is corresponding with a second pixel of the first frame, wherein the determining device is used for selecting an overdrive-voltage value from the overdrive table buffer according to the first pixel and the second pixel; wherein memory storage is provided within a first chipset, and the first chipset comprises a first active face and a plurality of first bond pads provided on the active face; the determining device is provided within a second chipset, the second chipset comprises a second active face and a plurality of second bond pads provided on the second active face, wherein the first chipset and the second chipset are stacked with each other, the second bond pads are electrically connected to the first bond pads respectively.

### BRIEF DESCRIPTION OF THE DRAWINGS

It will be understood that the figures are not to scale since the individual layers are too thin and the thickness differences of various layers too great to permit depiction to scale.

FIG. 1(a) shows a block diagram of a general LCD in respect of the internal structure.

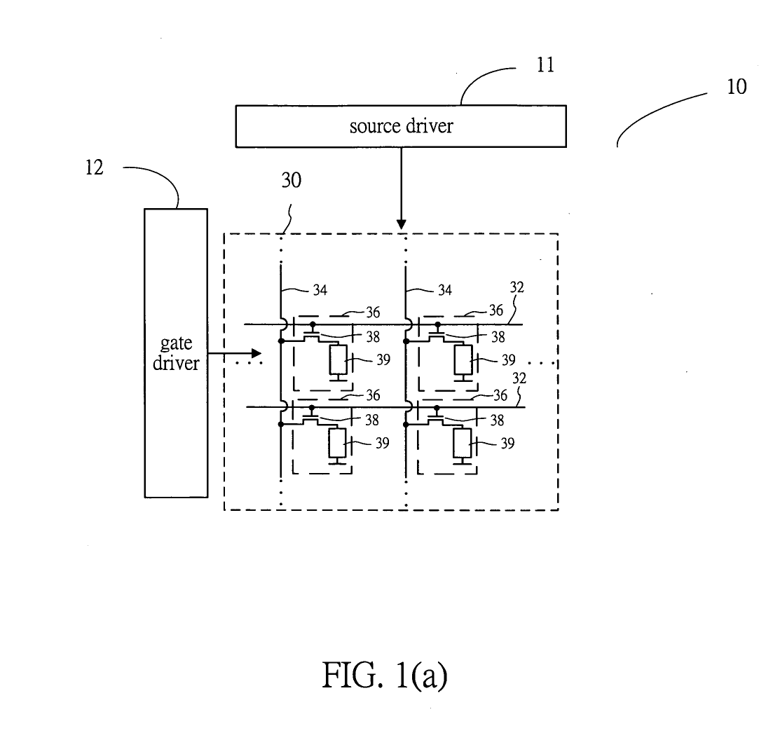

FIG. 1(b) shows a relation chart according to the voltage on the liquid crystal element and the time.

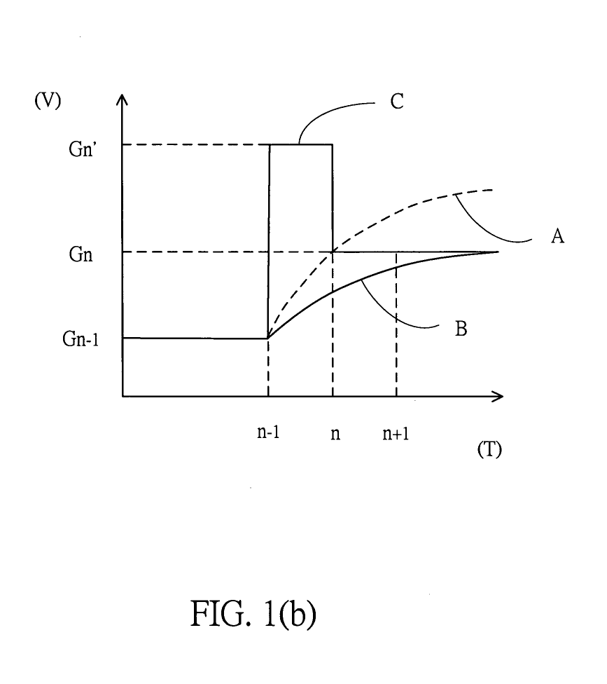

FIG. 2(a) shows a table view of an original overdrive table.

FIG. 2(b) shows a table view of shortened overdrive table.

FIG. 3(a) shows a block diagram of a preferred embodiment of the present invention in respect of an overdrive apparatus for advancing the response time of a LCD.

FIG. 3(b) shows a block diagram of another preferred embodiment of the present invention in respect of an overdrive apparatus for advancing the response time of a LCD.

FIG. 3(c) shows a block diagram of another preferred embodiment of the present invention in respect of an overdrive apparatus for advancing the response time of a LCD.

FIG. 4(a) shows a vertical view of a preferred embodiment of the present invention regarding to an overdrive apparatus in respect of the stacked system integration package on package structure.

FIG. 4(b) shows a vertical view of a preferred embodiment of the present invention regarding to an overdrive apparatus in respect of another stacked system integration package on package structure.

### DETAILED DESCRIPTION OF THE INVENTION

The structural features and the effects to be achieved may further be understood and appreciated by reference to the presently preferred embodiments together with the detailed description.

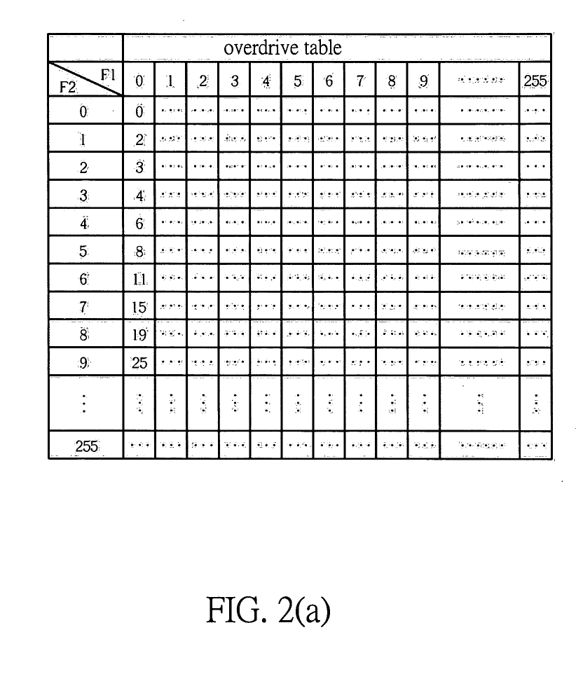

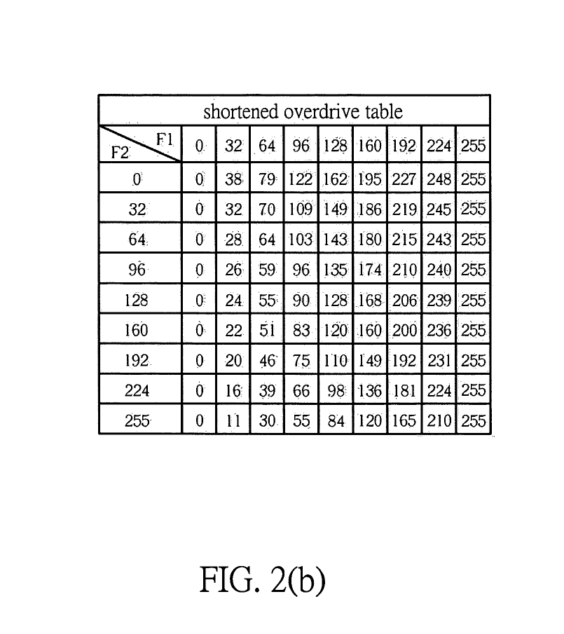

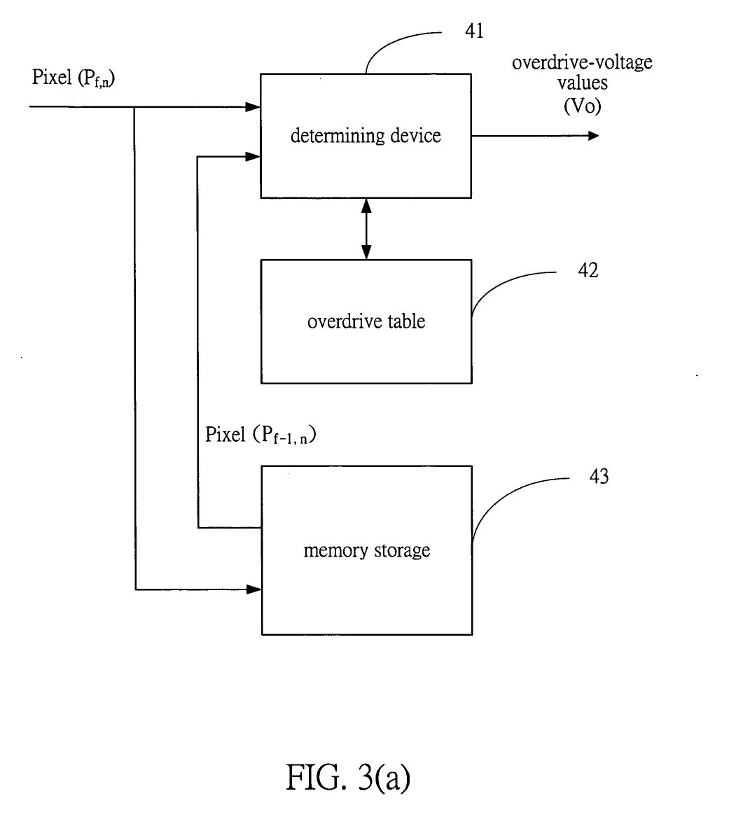

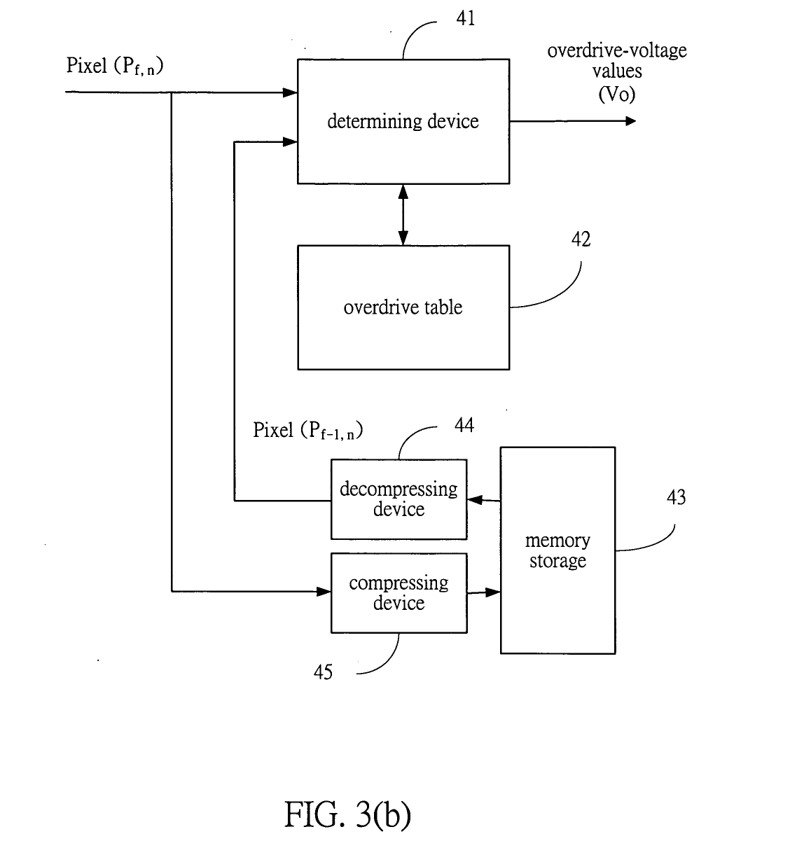

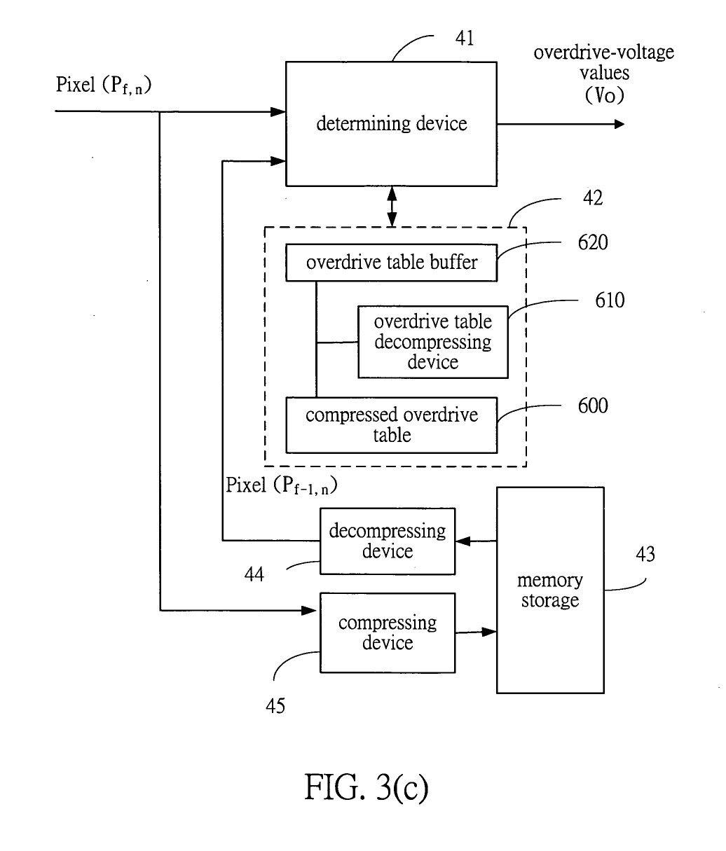

Referring to FIG. 3(a), a block diagram of a preferred embodiment of the present invention in respect of an overdrive apparatus for advancing the response time of a LCD is disclosed. The overdrive apparatus comprises a determining device 41, an overdrive table 42, and a memory storage 43, wherein the overdrive table 42 is used for saving a plurality of overdrive-voltage values, and the memory storage 43 is used for saving a first frame. The determining device 41 receives a first pixel P_{f,n}, and the first pixel P_{f,n} is corresponding with a second pixel P_{f-1,n} of the first frame, and furthermore, the determining device can select an overdrive-voltage value from the overdrive table 42 according to the first pixel P_{f,n} and the second pixel P_{f-1,n}. After the f-1 ordinal frame has been displayed on the LCD, while the n ordinal pixel P_{f,n} of the f ordinal frame, such as the first pixel regarding to the embodiment of the present invention, would be displayed, the determining device 41 will receive the first pixel Pf,n, and further receive the n ordinal pixel P_{f-1,n}, such as the second pixel regarding to the embodiment of the present invention, of the f-1 ordinal frame, such as the first frame regarding to the embodiment of the present invention, further saved within the memory storage 43. Thus, the determining device 41 will select an overdrive-voltage value from the overdrive table 42 according to the first pixel P_{f,n} and the second pixel P_{f-1,n}. For example, referring to FIG. 2(b) again, if the value of the first pixel P_{f,n} is 32, and the value of second pixel P_{f-1,n} is 128, then the overdrive-voltage value should be 24.

Referring to 4(a), a vertical view of a preferred embodiment of the present invention regarding to an overdrive apparatus in respect of the stacked system integration package on package structure is disclosed. The memory storage 43 is provided within a first chipset 410, the first chipset 410 comprises a first active face and a plurality of first bond pads 411 provided on the first active face. The determining device 41 is provided within a second chipset 420, the second chipset 420 comprises a second active face and a plurality of second bond pads 421 provided on the second active face, wherein the first chipset 410 and the second chipset 420 are stacked with each other, and the second bond pads 421 are electrically connected to the first bond pads 411. The first chipset 410 is provided within a leading-wire substrate 450, and the active face of the first chipset 410 is on the top. The second chipset 420 is provided on the first chipset 410, and the second active face of the second chipset 420 is on the top. Furthermore, the first chipset 410 and the second chipset 420 are formed as a crisscross structure. The second bond pads 421 are electrically connected to the first bond pads 411 through the leading-wire or the soldering-wire.

Regarding to an embodiment of the present invention, the second bond pads 421 are connected to the first bond pads 411 through the leading-wire and the soldering-wire, and electrically coupled to the connecting pads 451. According to the crisscross structure, the right and left sides of the second chipset 420 are protruded out of the first chipset 410 for preventing too many no connection (NC) pins occurred since the wire bonding process is distributed over the package pins at each side direction thereof efficiently. And, the overlap portion between the second chipset 420 and the first chipset 410 can be used for connecting with each other. Certainly, the first bond pads 411 and the connecting pads 451 can be connected through soldering-wires as well, according to the requirement of the circuit, otherwise, the third bond pads 431 provided on the protrudent side of the second chipset 420 can be connected to the connecting pads 451 directly through the soldering-wire.

According to another embodiment, the chipsets 410 and 420 can be without the limitation of forming as the crisscross structure, practically, any side of the top chipset protruded out of the bottom chipset would be acceptable for distributing the wire-bonding process over each side direction thereof efficiently, accordingly, once the protrudent portion is larger, the effect as mentioned result would be more obvious.

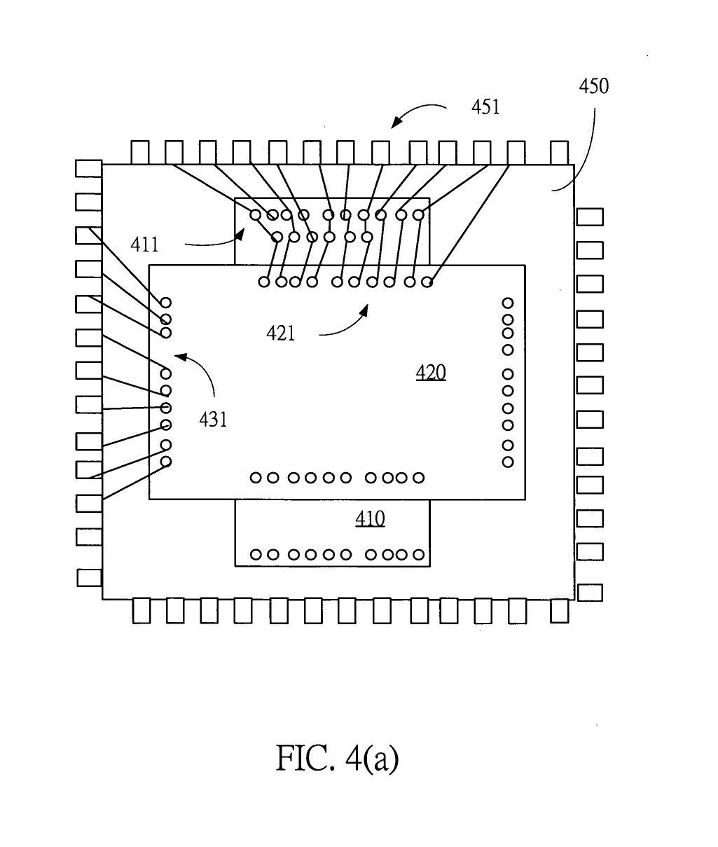

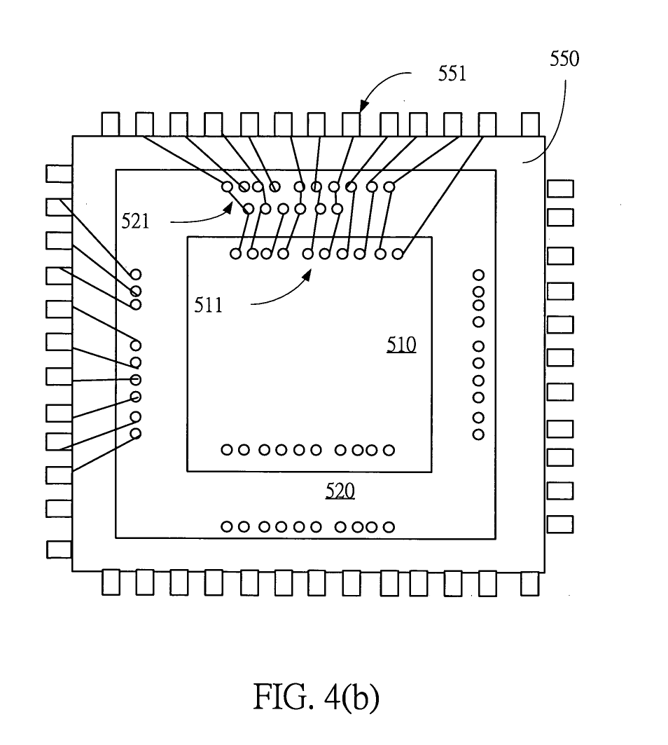

Regarding to the embodiment of the present invention, the first chipset 410 is a known good die for benefiting the integration of the package, and the leading-wire substrate is as a multiple pins lead frame, such as TQFP, LQFP, or TSOP lead frame. For simplifying the structure, the leading-wire substrate is supportable with single voltage source only, such as 2.5V Regarding to another embodiment, once the area of the first chipset is smaller than the second chipset, the first chipset could be placed within the peripheral of the second chipset, as shown on FIG. 4(b), wherein the leading-wire substrate. 550 comprises a top surface and a plurality of connecting pads or pins 551 provided on the top surface. The second chipset 520 is provided on the top of the second chipset 520. Therefore, partial second bond pads 521 of the second chipset 520 can be connected to partial connecting pads, and the other of second bond pads 521 can be connected to the partial first bond pads 511 of the first chipset 510. Surely, if it is necessary, the other of the first bond pads 510 can be connected to partial connecting pads 551 as well.

Referring to FIG. 3(b), a block diagram of another preferred embodiment of the present invention in respect of an overdrive apparatus for advancing the response time of a LCD is disclosed. The overdrive apparatus comprises a determining device 41, an overdrive table 42, a memory storage 43, a decompressing device 44, and a compressing device 45. The overdrive table 42 is used for saving a plurality of overdrive-voltage values, the compressing device 45 is used for compressing an original frame and generating a compressed frame further saved within the memory storage 43, thereafter, since the compressed data quantity has been shortened, the memory capacity of the memory storage can be saved. The decompressing device 44 is used for decompressing the compressed frame and generating a first frame. The determining device 41 can select an overdrive-voltage value V₀ from the overdrive table 42 according to the first pixel P_{f,n} and the second pixel P_{f-1,n}, wherein the second pixel P_{f-1,n} is corresponding with the first frame.

As well as the previous mentioned description of FIG. 4(a), regarding to the embodiment, the memory storage 43 can be provided within a first chipset 410, the determining device 41 can be provided within a second chipset 420, and the first chipset 410 is provided on a leading-wire substrate 450, wherein the first chipset 410 and the second chipset 420 are stacked with each other, and the second bond pads 421 are electrically connected to the first bond pads 411. The second bond pads 421 can be connected to the first bond pads 411 through the leading-wire or the soldering-wire and electrically coupled with the connecting pads 451. The overlap portion between the second chipset 420 and the first chipset 410 can be used for connecting with each other. The first bond pads 411 can be electrically connected to the connecting pads 451 according to the requirement of the circuit, otherwise, the third bond pads 431 protruded out of the first chipset 410 can be directly connected to the connecting pads 451 of the leading-wire substrate through the soldering-wires, wherein the third bond pads are provided on the side of the second chipset 420. As shown on FIG. 4(b), the second chipset 520 is provided on the leading-wire substrate 550, and the first chipset 510 is provided on the second chipset 520. The area of the first chipset 510 is smaller than the second chipset 520, and the first chipset 510 is placed within the peripheral of the second chipset 520. The partial second bond pads 521 can be electrically connected to the partial connecting pads 551, and the other of the second bond pads are electrically connected to the partial first bond pads 511. Certainly, for the demand, the other of first bond pads of the first chipset 510 can be connected to the partial connecting pads as well.

Referring to FIG. 3(c), a block diagram of another preferred embodiment of the present invention in respect of an overdrive apparatus for advancing the response time of a LCD is disclosed. The overdrive table 42 comprises a compressed overdrive table 600, an overdrive table decompressing device 610, and an overdrive table buffer, wherein the compressed overdrive table 600 is used for saving a plurality of compressed overdrive-voltage values, the overdrive table decompressing device 610 is used for decompressing the compressed overdrive-voltage values and generating a plurality of overdrive-voltage values, and the overdrive table buffer is used for saving the overdrive-voltage values. Therefore, since the compressed data quantity is shortened, the memory capacity required by the overdrive table 42 can be saved. The compressing device 45 is used for compressing an original frame and generating a compressed frame further saved within the memory storage 43. The decompressing device 44 is used for decompressing the compressed frame and generating a first frame. The determining device 41 can select an overdrive-voltage values V₀ from the overdrive table buffer 620 according to the first pixel P_{f,n} and the second pixel P_{f-1,n}, wherein the second pixel P_{f-1,n} is corresponding with the first frame. Correspondingly, the rest of operations regarding to the overdrive apparatus are as well as the previous mentioned description.

According to the comparison between the prior art and the present invention, the present invention discloses advantages of saving the memory capacity and distributing the wire-bonding process over each side direction of the chipset according to the protrudent portion of the top chipset, thus, the number of pins would be precise and further achieve the package with the lowest cost, as well as, the memory utility would be more flexible.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

I claim:

1. An overdrive apparatus for advancing the response time of a liquid crystal display (LCD), comprising:
a overdrive table for saving a plurality of overdrive-voltage values;
a memory storage for saving a first frame; and
a determining device for receiving a first pixel, wherein said first pixel is corresponding with a second pixel of said first frame, wherein said determining device is used for selecting an overdrive-voltage value from said overdrive table according to said first pixel and said second pixel;
wherein memory storage is provided within a first chipset, and said first chipset comprises a first active face and a plurality of first bond pads provided on said active face; said determining device is provided within a second chipset, said second chipset comprises a second active face and a plurality of second bond pads provided on said second active face, wherein said first chipset and said second chipset are stacked with each other, said second bond pads are electrically connected to said first bond pads respectively.

2. The overdrive apparatus of claim 1 further comprising:
a leading-wire substrate comprising a top surface, a plurality of first connecting pads, and a plurality of second connecting pads;
wherein said first connecting pads and said second connecting pads are provided on said top surface;
wherein said first chipset is provided on said top surface of said leading-wire substrate, and said first active face of said first chipset is on the top;
wherein said first bond pads are connected to said first connecting pads;
wherein said second chipset is provided on said first chipset, and said second active face of said second chipset is on the top; and
wherein said second chipset further comprises a first side protruded out of a first edge of said first chipset.

3. The overdrive apparatus of claim 2, wherein said second chipset and said first chipset are formed as a crisscross structure.

4. The overdrive apparatus of claim 2, wherein said second chipset further comprises a plurality of third bond pads provided on said first side of said second chipset, said third bond pads are electrically connected to said second connecting pads.

5. The overdrive apparatus of claim 2, wherein said leading-wire substrate is supportable with single voltage source input only, and said leading-wire substrate is a multiple pins lead-frame.

6. The overdrive apparatus of claim 2, wherein said first chipset is as a known good die.

7. The overdrive apparatus of claim 1, further comprising:
a leading-wire substrate comprising a top surface, a plurality of first connecting pads, and a plurality of second connecting pads;
wherein said first connecting pads and said second connecting pads are provided on said top surface;
wherein said second chipset is provided on said leading-wire substrate, and said second active face of said second chipset is on the top;
wherein said second bond pads are electrically connected to said first connecting pads; and
wherein said first chipset is provided on said second chipset, and said first active face of said first chipset is on the top.

8. The overdrive apparatus of claim 7, wherein the area of said first chipset is smaller than said second chipset, and said first chipset is placed within the peripheral of said second chipset.

9. The overdrive apparatus of claim 7, wherein said first chipset further comprises a plurality of fourth bond pads provided on said first active face, said fourth bond pads are electrically connected to said second connecting pads.

10. The overdrive apparatus of claim 7, wherein said leading-wire substrate is supportable with single voltage source input only, and said leading-wire substrate is a multiple pins lead frame.

11. The overdrive apparatus of claim 7, wherein said first chipset is as a known good die.

12. An overdrive apparatus for advancing the response time of a liquid crystal display (LCD), comprising:
a overdrive table for saving a plurality of overdrive-voltage values;
a compressing device for compressing an original frame and generating a compressed frame;
a memory storage for saving a first frame;
a decompressing device for decompressing said compressed frame and generating a first frame; and
a determining device for receiving a first pixel, wherein said first pixel is corresponding with a second pixel of said first frame, wherein said determining device is used for selecting an overdrive-voltage value from said overdrive table according to said first pixel and said second pixel;
wherein memory storage is provided within a first chipset, and said first chipset comprises a first active face and a plurality of first bond pads provided on said active face; said determining device is provided within a second chipset, said second chipset comprises a second active face and a plurality of second bond pads provided on said second active face, wherein said first chipset and said second chipset are stacked with each other, said second bond pads are electrically connected to said first bond pads respectively.

13. The overdrive apparatus of claim 12, further comprising:
a leading-wire substrate comprising a top surface, a plurality of first connecting pads, and a plurality of second connecting pads;
wherein said first connecting pads and said second connecting pads are provided on said top surface;
wherein said first chipset is provided on said top surface of said leading-wire substrate, and said first active face of said first chipset is on the top;
wherein said first bond pads are connected to said first connecting pads;
wherein said second chipset is provided on said first chipset, and said second active face of said second chipset is on the top; and
wherein said second chipset further comprises a first side protruded out of a first edge of said first chipset.

14. The overdrive apparatus of claim 13, wherein said second chipset and said first chipset are formed as a crisscross structure.

15. The overdrive apparatus of claim 13, wherein said second chipset further comprises a plurality of third bond pads provided on said first side of said second chipset, said third bond pads are electrically connected to said second connecting pads.

16. The overdrive apparatus of claim 13, wherein said leading-wire substrate is supportable with single voltage source input only, and said leading-wire substrate is a multiple pins lead frame.

17. The overdrive apparatus of claim 13, wherein said first chipset is as a known good die.

18. The overdrive apparatus of claim 12, further comprising:
a leading-wire substrate comprising a top surface, a plurality of first connecting pads, and a plurality of second connecting pads;
wherein said first connecting pads and said second connecting pads are provided on said top surface;
wherein said second chipset is provided on said leading-wire substrate, and said second active face of said second chipset is on the top;
wherein said second bond pads are electrically connected to said first connecting pads; and
wherein said first chipset is provided on said second chipset, and said first active face of said first chipset is on the top.

19. The overdrive apparatus of claim 18, wherein the area of said first chipset is smaller than said second chipset, and said first chipset is placed within the peripheral of said second chipset.

20. The overdrive apparatus of claim 18, wherein said first chipset further comprises a plurality of fourth bond pads provided on said first active face, said fourth bond pads are electrically connected to said second connecting pads.

21. The overdrive apparatus of claim 18, wherein said leading-wire substrate is supportable with single voltage source input only, and said leading-wire substrate is a multiple pins lead frame.

22. The overdrive apparatus of claim 18, wherein said first chipset is as a known good die.

23. An overdrive apparatus for advancing the response time of a liquid crystal display (LCD), comprising:
a compressing overdrive table for saving a plurality of compressed overdrive-voltage values;
an overdrive table decompressing device for decompressing said compressed overdrive-voltage values and generating a plurality of overdrive-voltage values;
an overdrive table buffer for saving said overdrive-voltage values;
a memory storage for saving a first frame; and
a determining device for receiving a first pixel, wherein said first pixel is corresponding with a second pixel of said first frame, wherein said determining device is used for selecting an overdrive-voltage value from said overdrive table buffer according to said first pixel and said second pixel;
wherein memory storage is provided within a first chipset, and said first chipset comprises a first active face and a plurality of first bond pads provided on said active face; said determining device is provided within a second chipset, said second chipset comprises a second active face and a plurality of second bond pads provided on said second active face, wherein said first chipset and said second chipset are stacked with each other, said second bond pads are electrically connected to said first bond pads respectively.

24. The overdrive apparatus of claim 23, further comprising:
a leading-wire substrate comprising a top surface, a plurality of first connecting pads, and a plurality of second connecting pads;
wherein said first connecting pads and said second connecting pads are provided on said top surface;
wherein said first chipset is provided on said top surface of said leading-wire substrate, and said first active face of said first chipset is on the top;
wherein said first bond pads are connected to said first connecting pads;
wherein said second chipset is provided on said first chipset, and said second active face of said second chipset is on the top; and
wherein said second chipset further comprises a first side protruded out of a first edge of said first chipset.

25. The overdrive apparatus of claim 23, further comprising:
a leading-wire substrate comprising a top surface, a plurality of first connecting pads, and a plurality of second connecting pads;
wherein said first connecting pads and said second connecting pads are provided on said top surface;
wherein said second chipset is provided on said leading-wire substrate, and said second active face of said second chipset is on the top;
wherein said second bond pads are electrically connected to said first connecting pads;
wherein said first chipset is provided on said second chipset, and said first active face of said first chipset is on the top; and
wherein the area of said first chipset is smaller than said second chipset, and said first chipset is placed within the peripheral of said second chipset.
